(19) United States
(12) Patent Application Publication
(10) Pub. No.: US 2026/0280288 A1
(43) Pub. Date: Sep. 17, 2026

(54) Cost-efficient operation of an installation of the metal industry and of additional sub-systems of an entire system

(71) Applicant: Primetals Technologies Germany GmbH, Erlangen (DE)

(72) Inventor: Klaus Weinzierl, Nürnberg (DE)

(21) Appl. No.: 19/471,522

(22) PCT Filed: Apr. 2, 2024
(86) PCT No.: PCT/EP2024/058900

§ 371 Date: Oct. 1, 2025

(30) Foreign Application Priority Data
Apr. 5, 2023 (EP) 23166773.4
May 24, 2023 (EP) 23175001.9

(51) Int. Cl. H02J 3/00; C25B 1/02; H01M 10/054; H01M 10/42

(52) U.S. Cl. CPC H02J 3/004; C25B 1/02; H01M 10/054; H01M 10/425; H01M 2010/4271; H01M 2220/10

(57) ABSTRACT

Please replace the Abstract with the following Abstract:

An overall system that includes, as a subsystem, an electrical energy storage device and further subsystems, at least one metal industry installation, and a control device that controls the subsystems. The further subsystems are connected to one another and to an electrical supply grid to transmit electrical energy. A control device controls the draw of electrical energy by the further subsystems.

### TECHNICAL FIELD

The present invention is based on an operating method for an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein a control device that controls the overall system is made aware of current states of the subsystems.

The present invention is furthermore based on a control program for a control device for an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein the control program comprises machine code able to be executed by the control device,
wherein the execution of the machine code by the control device causes the control device to control the overall system in line with such an operating method.

The present invention is furthermore based on a control device for an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein the control device is programmed, by way of such a control program, such that the control device, when the machine code of the control program is executed, controls the overall system in line with such an operating method.

The present invention is furthermore based on an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein the overall system comprises such a control device that, when the machine code of such a control program is executed, controls the overall system in line with such an operating method.

### Prior Art

The abovementioned subjects are known for example from the essay “Grüne Energieversorgung der Stahlindustrie” [Green Energy Supply for the Steel Industry], Stahl und Eisen [Steel and Iron], August 2022, pages 22 to 24.

KR 2019 0136300 A discloses an industrial process to which an

energy storage device is assigned. The industrial process may be a more or less complex technical process that comprises multiple subprocesses that build on one another and interact with one another. The industrial process has various types of loads, namely loads that must be supplied with energy at all times, loads that are able to be switched off, and loads with a settable energy consumption. The actual energy consumption of the various components of the industrial installation is determined. The operation of the industrial installation and of the energy storage device are coordinated so as to achieve minimal costs.

U.S. Pat. No. 10,354,297 B2 discloses an arrangement comprising a domestic consumer, an energy producer and an energy storage device. The operation of the energy storage device may be ascertained taking into account a planned energy consumption of the consumer. Weather data may furthermore also be used in conjunction. It is also possible to take into account price information for drawing electrical energy from a supply grid and for feeding electrical energy into the supply grid.

TW 201 235 124 A discloses that the energy consumption of a metal industry installation—specific mention is made of a rolling mill—is able to be predicted with good accuracy when the operating mode of the metal industry installation is known.

U.S. Pat. No. 8,288,888 B2 discloses an electrolysis installation coupled to a wind farm. Other loads and other energy sources may additionally be present. The other loads and energy sources may also take the form of electrical energy storage devices. The hydrogen generated by the electrolysis installation may be transferred to an affiliated chemical plant or refinery.

US 2015/0 051 745 A1 discloses an operating method for an overall system, in which the overall system comprises, as a subsystem, an electrical energy storage device and further subsystems. The further subsystems comprise a metal industry installation, wherein the metal industry installation and the electrical energy storage device are connected directly or indirectly to one another and to an electrical supply grid in order to transmit electrical energy. A control device that controls the overall system is made aware of a current state of the electrical energy storage device and current states of the further subsystems and also, with respect to a first time horizon, planned first operating modes of the further subsystems. The control device operates the further subsystems during the first time horizon based on the planned first operating modes.

US 2023/0 013 847 A1 discloses an operating method for an overall system, in which the overall system comprises, as a subsystem, an electrical energy storage device and further subsystems. The further subsystems comprise a metal industry installation. The metal industry installation and the electrical energy storage device are connected directly or indirectly to one another and to an electrical supply grid in order to transmit electrical energy. A control device that controls the overall system is made aware of a current state of the electrical energy storage device, current states of the further subsystems and, with respect to a first time horizon, a planned first draw of electrical energy from the supply grid and planned first operating modes of the further subsystems. The control device defines a planned second draw of electrical energy taking into account second operating modes of the further subsystems that are known to the control device and planned for a second time horizon immediately following the first time horizon. The control device operates the further subsystems during the first time horizon based on the planned first operating modes, wherein the control device draws electrical energy from the supply grid during the first time horizon in accordance with the planned first draw of electrical energy, and operates the further subsystems during the second time horizon based on the planned second operating modes and draws electrical energy from the supply grid during the second time horizon in accordance with the defined second draw of electrical energy.

The essay “Optimal Industrial Load Control in Smart Grid”, IEEE Transactions on Smart Grid, Vol. 7, No. 5, September 2016, pages 2305 to 2316, discloses an overall system comprising industrial consumers that are connected to an electrical supply grid. Components of a steel plant are listed as an example of such industrial consumers. In some embodiments, an electrical energy storage device may be present. The operation of the electrical consumers (including the electrical energy storage device) is to be optimized. That essay thus discloses an operating method for an overall system, wherein the overall system comprises, as a subsystem, an electrical energy storage device and further subsystems, wherein the further subsystems comprise a metal industry installation, wherein the metal industry installation and the electrical energy storage device are connected directly or indirectly to one another and to an electrical supply grid in order to transmit electrical energy. That essay also discloses predictive pricing. However, the operating modes of the further subsystems do not yet appear to be defined, at least for the second time horizon.

US 2016/0 291 554 A1 relates to an overall system that may comprise an electrical energy storage device and a metal industry installation. An energy management system is present and controls the various parts of the installation.

### SUMMARY OF THE INVENTION

In the past when ascertaining the operation of metal industry installations, the costs incurred in the process—including the energy costs incurred in the process—were taken into account. However, they were taken into account only in the sense that the overall electrical energy demand and the resulting electrical energy costs were taken into account. In the course of the shift toward renewable energies, the availability of electrical energy (including the temporal fluctuations of the costs incurred for electrical energy) has to be taken into account to a considerably greater extent, since the availability and thus also the costs of electrical energy will be subject to considerably greater fluctuations in the future than they have been in the past.

The—expected—future power demand of the metal industry installation, on the one hand, and the—expected—future price of electrical energy drawn from the supply grid, on the other hand, are crucial for the efficient use of the electrical energy storage device in the context of the present invention.

Although the abovementioned essay explains that the metal industry installation and the electrical energy storage device are controlled and operated by a smart energy management system, it does not contain any more detailed explanations regarding the implementation of the smart energy management system.

The object of the present invention is to provide possibilities that achieve cost-efficient operation of an overall system that comprises, as subsystems, a metal industry installation and electrical energy storage device.

The object is achieved by an operating method having the features of claim 1. Dependent claims 2 to 6 relate to advantageous configurations of the operating method.

According to the invention, an operating method of the type mentioned at the outset is designed as follows:
wherein the control device is made aware, with respect to a first time horizon, of a planned first draw of electrical energy from the supply grid and planned first operating modes of the further subsystems,
wherein the control device determines an expected end state of the electrical energy storage device with respect to the end of the first time horizon, based on the planned first draw and the planned first operating modes,
wherein the control device defines a planned second draw of electrical energy taking into account the expected end state of the electrical energy storage device and second operating modes of the further subsystems that are known to the control device and planned for a second time horizon immediately following the first time horizon,
wherein the control device operates the further subsystems during the first and second time horizon based on the planned first and second operating modes and draws electrical energy from the supply grid during the first and second time horizon in accordance with the planned first draw and the defined second draw of electrical energy.

Provision is made here for the control device, in order to define the planned second draw of electrical energy,
to determine a demand for electrical energy for the operation of the further subsystems during the second time horizon based on the planned second operating modes, and
to define the second draw of electrical energy from the supply grid during the second time horizon taking into account the demand for electrical energy for the operation of the further subsystems during the second time horizon and the expected end state of the electrical energy storage device and a target state of the electrical energy storage device desired at the end of the second time horizon.

This makes it particularly simple to determine the planned second draw of electrical energy. The planned second operating modes may be specified to the control device. As an alternative, they may be determined independently by the control device, for example as part of an optimization.

The term “subsystems”, when used without any further additions, both above and below, encompasses all subsystems, that is to say including the electrical energy storage device. The term “further subsystems”, on the other hand, does not encompass the electrical energy storage device, but rather only the other subsystems. By way of example, the first time horizon may be 24 hours. The second time horizon is usually significantly shorter than the first time horizon. By way of example, it may be 1 hour or a few hours. The stated values are typical. However, the present invention is not limited to the stated values for the two time horizons.

It is possible for the control device first to define the planned first draw of electrical energy from the supply grid before the current execution of the operating method for the first time horizon, and then to define the planned first operating modes of the various further subsystems based on the planned first draw of electrical energy. As an alternative, the opposite procedure is possible. As another alternative, it is possible for the control device to first be made aware of the planned first operating modes of the further subsystems (for example because they are specified to the control device or are determined by the control device), and the control device then determines the planned first draw of electrical energy based on the planned first operating modes. In any case, however, the planned operating mode of the electrical energy storage device is an operating mode derived from the defined draw of electrical energy and the associated planned first operating modes of the further subsystems. The electrical energy storage device is, so to speak, the slave listening to its masters, wherein the masters are the further subsystems and the defined draw of electrical energy from the supply grid.

The present invention is based on the fact that the expected price of electrical energy drawn from the supply grid may be defined in each case individually for different periods. On a spot market, the price is often fixed only for a relatively limited period, for example only 24 hours in advance. Here, specific quantities of power are traded for fixed periods at a respective spot market price.

If, during subsequent operation of the overall system—that is to say for example 24 hours after the purchase of certain quantities of electrical energy—the previously purchased quantity of electrical energy is drawn, the agreed tariff will also be invoiced. If, on the other hand, more or less electrical energy is drawn, the actual price of electrical energy drawn from the supply grid depends o a number of factors. The actual price incorporates in particular whether and, where applicable, at what expense additionally drawn electrical energy had to be procured by the operator of the supply grid or whether and, where applicable, at what expense electrical energy that was purchased from the operator of the supply grid but not drawn was able to be utilized elsewhere.

This creates considerable uncertainty for the operator of the overall system. It would be much more reliable if it were able to be ensured that the previously purchased quantity of electrical energy—no more and no less—is actually also drawn from the supply grid during subsequent operation of the overall system.

It is precisely this that is ensured by the procedure according to the invention.

The current states of the subsystems may be defined as required. These may in particular comprise “normal” operating states, operating limits and wear states.

Specifically for the electrical energy storage device, the current state comprises in particular the extent (in percentage and/or absolute terms) to which the energy storage device is charged and the temperature of storage cells of the energy storage device. Furthermore, the energy storage device state may also comprise the state of wear of the energy storage device or parts of the energy storage device. The energy storage device state may furthermore comprise maximum possible operating variables in principle and maximum possible operating variables at the current time, for example charging and discharge currents. This also applies similarly to the actual and expected end state of the electrical energy storage device at the end of the first time horizon.

It is possible for the overall system to have only a single electrical energy storage device or indeed to have multiple electrical energy storage devices that are handled by the control device, but uniformly in the sense of the electrical energy storage device mentioned at the outset. Preferably, however, the overall system comprises a further electrical energy storage device, specifically as a further subsystem. The classification of the further electrical energy storage device as a further subsystem means not only that the control device is made aware of a current state of the further electrical energy storage device and that the further electrical energy storage device is controlled by the control device. Rather, this classification also means that the control device is made aware, with respect to the first and second time horizon, of the planned first and second operating mode of the further electrical energy storage device, and the further electrical energy storage device is accordingly also operated in line therewith. The control device is thus first made aware of the operating mode of the further electrical energy storage device for both time horizons. Only thereafter is the second draw of electrical energy defined for the second time horizon. For the second time horizon and restricted to the two electrical energy storage devices, the sequence is therefore first being made aware of the second operating mode of the further electrical energy storage device, then defining the draw of electrical energy for the second time horizon and thereby, for this time horizon, defining an expected operating mode for the electrical energy storage device, which, although it is a subsystem, is not a further subsystem of the overall system.

If the further electrical energy storage device is present, it preferably differs from the other electrical energy storage device in terms of its possible performance limits, for example in terms of its capacity and its maximum possible or permissible charging and discharge current (or a corresponding power). By way of example, the further electrical energy storage device may have a significantly smaller storage capacity, but a significantly greater maximum charging and discharge power, than the other electrical energy storage device. Mention may be made, by way of example, of the values of 10 MWh and 100 MW for the further electrical energy storage device and of the values of 100 MWh and 25 MW for the other electrical energy storage device. The further electrical energy storage device may be designed for example as a sodium-ion battery, and the other electrical energy storage device may be designed for example as a redox flow battery or as a sodium-sulfur battery.

The way in which the control device is made aware of the second operating mode for the further electrical energy storage device for the second time horizon may be determined as required. In the simplest case, a specification is given by an operator. Generally speaking, however, it is much better for the control device first to define the planned second operating mode of the further electrical energy storage device by utilizing the planned second operating modes of the further subsystems (now with the exception of the further electrical energy storage device) and only then to define the planned second draw of electrical energy. The control device thus determines a predictive definition of the planned second operating mode for the further electrical energy storage device based on the planned second operating modes with which the other further subsystems are to be operated.

During operation of the further subsystems (generally with the exception of the further electrical energy storage device), a wide variety of problems may occur. Such problems, which have to be taken into account, may result in the electrical energy demand of the further subsystems (in this case too with the exception of the further electrical energy storage device) deviating from an energy demand in accordance with the planned first operating modes. The controller therefore preferably checks, during the first time horizon, whether such deviations occur due to unconsidered circumstances. In the event that the energy demand does not deviate, the control device maintains the planned first operating mode of the further electrical energy storage device and a planned first operating mode of the electrical energy storage device based on the planned first draw of electrical energy from the supply grid. If, on the other hand, the energy demand deviates,
the control device modifies the planned first operating mode of the further electrical energy storage device and/or the planned first operating mode of the electrical energy storage device as a priority, so that the planned first draw of electrical energy from the supply grid is maintained, and
the control device modifies the planned first operating modes of the further subsystems, with the exception of the further electrical energy storage device and/or the planned first draw of electrical energy, only if operating limits of the electrical energy storage device and/or the further electrical energy storage device cannot be complied with.

The latter changes, that is to say the change of the planned first operating modes of the further subsystems, with the exception of the further electrical energy storage device and/or the planned first draw of electrical energy, are carried out such that the operating limits of the electrical energy storage device and of the further electrical energy storage device are complied with.

Problems or unconsidered circumstances may of course occur even if no further electrical energy storage device is present. It is furthermore also possible—regardless of the reasons why—for the planned first operating mode of the further electrical energy storage device to be intended to be changed only as a lesser priority. It is therefore likewise possible for the control device
to check, during the first time horizon, whether operating limits of the electrical energy storage device are complied with during the remaining part of the first time horizon, despite unconsidered circumstances,
to maintain the planned first draw of electrical energy in the event that the operating limits are complied with, and
to modify the planned first operating modes and/or the planned first draw of electrical energy, in the event that the operating limits are not complied with, such that the operating limits of the electrical energy storage device are complied with.

Possible unconsidered circumstances are for example short-term changes to the first operating modes. The reason for such short-term changes may be for example problems in the further subsystems. Another possible reason may be that the overall system contains regenerative energy producers (for example a wind turbine and/or a photovoltaic installation), and their production of regenerative energy deviates from previous assumptions. Another unconsidered circumstance is problems with the electrical energy storage device itself

As a result, the planned first operating modes and/or the planned first draw of electrical energy may be changed even during the first time horizon. However, this only occurs if it is unavoidable.

The overall system often comprises an electrolysis installation as a further subsystem. In this case, the electrolysis installation is connected directly or indirectly to the metal industry installation, the electrical energy storage device and the electrical supply grid in order to transmit electrical energy. Furthermore, in this case, the current states comprise a current state of the electrolysis installation and the planned first and second operating modes comprise a respective operating mode for the electrolysis installation.

The object is furthermore achieved by a control program having the features of claim 7. According to the invention, the execution of the machine code by the control device causes the control device to control the overall system in line with an operating method according to the invention.

The object is furthermore achieved by a control device having the features of claim 8. According to the invention, the control device is programmed, by way of a control program according to the invention, such that the control device, when the machine code of the control program is executed, controls the overall system in line with an operating method according to the invention.

The object is furthermore achieved by an overall system having the features of claim 9. According to the invention, provision is made for the control device to be designed as a control device according to the invention, which, when the machine code of the control program is executed, controls the overall system in line with an operating method according to the invention.

### BRIEF DESCRIPTION OF THE FIGURES

The above-described properties, features and advantages of this invention, and the manner in which these are achieved, will become clearer and more clearly comprehensible in conjunction with the following description of one exemplary embodiment, which is explained in more detail in conjunction with the drawings. In the figures:

FIG. 1 shows an overall system,

FIG. 2 shows a flowchart,

FIG. 3 shows a timeline,

FIG. 4 shows a flowchart,

FIG. 5 shows a communication structure,

FIG. 6 shows a flowchart,

FIG. 7 shows a further flowchart,

FIG. 8 shows a further overall system,

FIG. 9 shows a flowchart, and

FIG. 10 shows a further flowchart.

### DESCRIPTION OF THE EMBODIMENTS

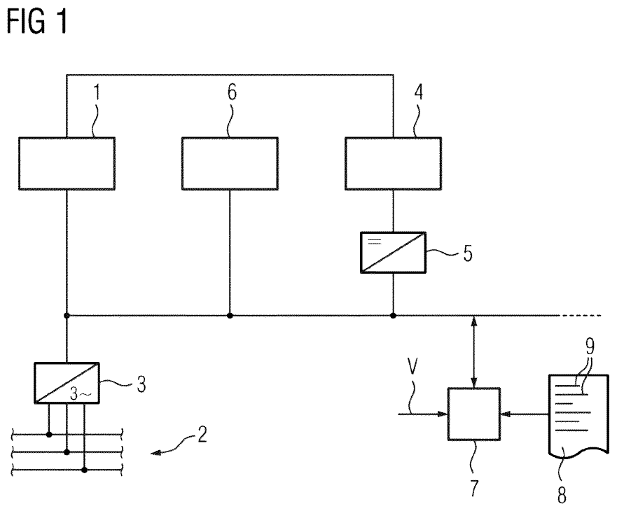

In accordance with FIG. 1, an overall system comprises a metal industry installation 1. The installation 1 may have multiple components. Examples of such installations 1 are components that are technologically upstream of a casting device. Examples of such components are an iron-producing component (for example a DRI installation), an electric arc furnace, a converter and a ladle installation. Another possible installation 1 is a hot strip mill. This installation is technologically downstream of a casting device.

The installation 1 consumes electrical energy during operation thereof. The installation 1 may draw the electrical energy from an electrical supply grid 2 to which the installation 1 is connected directly (not illustrated) or indirectly (for example via a power converter 3). The supply grid 2 is typically a three-phase grid and thus a multi-phase supply grid. The three-phase grid is often operated with a medium voltage in the range from 20 kV to 30 kV or with a high voltage of 110 kV.

The overall system often comprises an electrolysis installation 4 as a further subsystem. The invention will be explained below in conjunction with such an embodiment. However, the electrolysis installation 4 is not absolutely necessary. If it is not present, all content below relating to the electrolysis installation 4 no longer applies.

The electrolysis installation 4 also consumes electrical energy during operation thereof. The electrolysis installation 4 is therefore likewise connected to the supply grid 2. The electrolysis installation 4 requires a DC voltage to operate. A rectifier 5 is therefore usually arranged upstream of the electrolysis installation 4, and so there is only an indirect connection to the supply grid 2.

In some cases, the installation 1 requires hydrogen to operate. In this case, the installation 1 and the electrolysis installation 4 are connected directly or indirectly to one another in order to transfer hydrogen, in accordance with the illustration in FIG. 1. Any pumps, valves and the like are not also illustrated in FIG. 1.

The overall system furthermore comprises an electrical energy storage device 6 as a subsystem. The energy storage device 6 is connected directly or indirectly to the supply grid 2 at least in order to receive electrical energy, possibly also in order to output electrical energy. The energy storage device 6 is furthermore connected to the installation 1 and to the electrolysis installation 4 in order to output electrical energy. If the energy storage device 6 receives electrical energy, this is always drawn from the supply grid 2. If the energy storage device 6 outputs electrical energy, this is used primarily to cover the demands of the installation 1 and of the electrolysis installation 4 and only secondarily to feed into the supply grid 2. As a result—depending on whether the electrical energy output by the energy storage device 6 is greater or less than the electrical energy consumed by the installation 1 and electrolysis installation 4—electrical energy may thus temporarily be fed into the supply grid 2 or drawn from the supply grid 2.

It must be possible to set whether, and to what extent, electrical energy is supplied to the energy storage device 6 or whether, and to what extent, the electrical energy storage device 6 outputs electrical energy. For this purpose, a bidirectionally operable power converter unit is generally present. This power converter unit is not also illustrated in FIG. 1. Rather, it is considered to be part of the energy storage device 6.

The exact way in which the installation 1, the electrolysis installation 4 and the energy storage device 6 are electrically connected to one another and to the supply grid 2 is of lesser importance. In particular, rectifiers 5, inverters and other power converters 3 may be assigned to the various subsystems 1, 4 and 6, as required. However, it should be ensured that it is possible to transfer electrical energy from the energy storage device 6 to the installation 1 and the electrolysis installation 4 without a diversion via the supply grid 2.

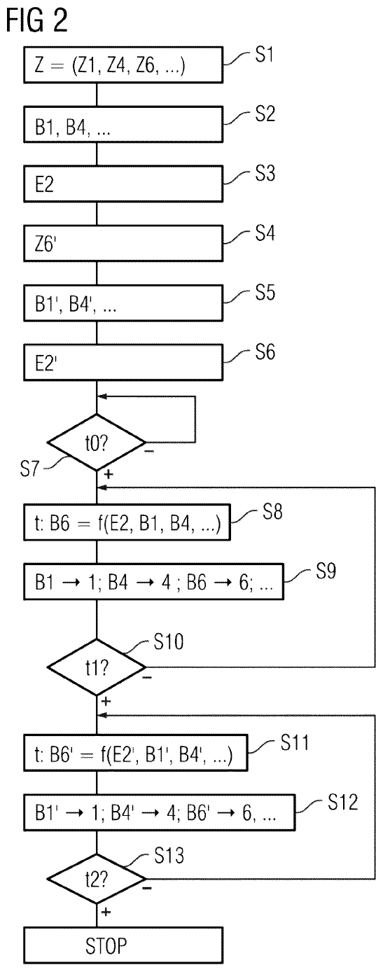

The overall system furthermore comprises a control device 7. The control device 7 is programmed with a control program 8. The control program 8 comprises machine code 9 able to be executed by the control device 7. The programming with the control program 8 causes the control device 7 to execute the machine code 9. The execution of the machine code 9 by the control device 7 causes the control device 7 to control the overall system in line with an operating method that is explained in more detail below in conjunction with FIG. 2. However, even before the operating method according to the invention is explained, it is pointed out that the control device 7 is explained below as being a uniform control device 7 that jointly controls the subsystems 1, 4 and 6 of the overall system. However, the control device 7 may likewise have its own sub-control device for controlling each of the subsystems 1, 4 and 6. In this case, appropriate information exchange and coordination must take place between the sub-control devices.

A distinction is also made below between the electrical energy storage device 6, on the one hand, and the further subsystems 1, 4, on the other hand. The “further subsystems” comprise only the raw materials industry installation 1 and, where applicable, the electrolysis installation 4, but not the electrical energy storage device 6. If, on the other hand, the term “subsystems” is used without the addition of “further”, this means all subsystems, that is to say not only the raw materials industry installation 1 and, where applicable, the electrolysis installation 4, but also the electrical energy storage device 6.

In accordance with FIG. 2, in a step S1, the control device 7 is made aware of a current state Z of the overall system. The current state Z comprises a respective current substate Z1, Z4, Z6 for the subsystems 1, 4, 6. The number in the respective current substate Z1, Z4, Z6 corresponds to the reference sign of the respective subsystem 1, 4, 6.

By way of example, substate Z1—assuming that corresponding components of the installation 1 are present—may comprise the following variables:
the production progress of an iron-producing installation,
the production progress of an electric arc furnace,
a process state of a continuous casting machine,
a temperature of a furnace upstream of a rolling mill,
states of wear of working rollers of roll stands of the rolling mill,
whether rolling passes are currently being carried out in the roll stands of the rolling mill.

Substate Z1 may furthermore comprise which materials are in which state at the current time in the installation 1. By way of example, substate Z1—assuming that corresponding materials are present in corresponding components of the installation 1—may comprise the following variables:
quantity and state of a batch in an electric arc furnace or in a ladle,
durations for which rolling stock has already been in a furnace,
temperatures of the rolling stock.

Substate Z4 may comprise for example a temperature and a chemical composition of the electrolysis fluid of the electrolysis installation 4 and a state of wear of the electrolysis installation 4.

### Substate Z6 Comprises at Least the State of Charge of the Energy

storage device 6, that is to say the extent to which the energy storage device 6 is charged. Substate Z6 may also comprise other variables, for example a temperature of the energy storage device 6 or a maximum possible or permissible charging and discharge current. Furthermore, substate Z6 may comprise a state of wear of the energy storage device 6.

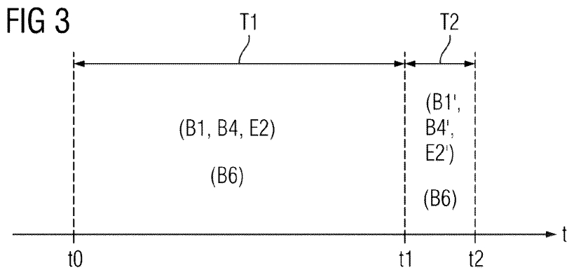

In a step S2, the control device 7 is made aware of planned first operating modes B1, B4 of the further subsystems 1, 4. According to FIG. 3, said operating modes B1, B4 relate to a first time horizon T1. According to FIG. 3, the first time horizon T1 extends over a significant period, for example over 20 hours, 22 hours, 24 hours or 26 hours. Of course, other periods are also possible. In a step S3, the control device 7 is also made aware, for the first time horizon T1, of a planned first draw E2 of electrical energy from the supply grid 2. The number “2” that has been added to the letter “E” here is intended to indicate that the draw of electrical energy takes place from the supply grid 2.

In a step S4, the control device 7 determines an expected end state Z6′ of the electrical energy storage device 6. The expected end state Z6′ relates to the end of the first time horizon T1. The control device 7 determines the expected end state Z6′ based on the planned first draw E2 and the planned first operating modes B1, B4. Generally speaking, the control device 7 also determines the expected end states of the further subsystems 1, 4 in step S4. However, this is of secondary importance within the scope of the present invention.

In a step S5, the control device 7 is made aware of planned second operating modes B1′, B4′ of the further subsystems 1, 4. The planned second operating modes B1′, B4′ relate—see FIG. 3—to a second time horizon T2, which immediately follows the first time horizon T1. The second time horizon T2 is generally considerably smaller than the first time horizon T1. By way of example, the second time horizon T2 may be 1 hour or a few hours.

The planned second operating modes B1′, B4′ may be specified to the control device 7. As an alternative, they may be determined by the control device 7, based on the end states of the other subsystems 1, 4 at the end of the first time horizon T1, for example in line with an operating method as explained in detail in the earlier, unpublished application “Kosteneffizienter Betrieb einer Anlage der Stahlindustrie und weiterer Teilsysteme eines Gesamtsystems” [Cost-efficient operation of a steel industry installation and further subsystems of an overall system” by Primetals Technologies Germany GmbH, official file reference 23 151 165.0, filed on 01.11.2023 at the European Patent Office.

In a step S6, the control device 7 defines a planned second draw E2′ of electrical energy. The definition is carried out taking into account the expected end state Z6′ of the electrical energy storage device 6 and the planned second operating modes B1′, B4′.

In a step S7, the control device 7 waits for a time to, that is to say the start of the first time horizon T1.

Starting from the time to, the control device 7, in a step S8, determines the associated operating mode B6 of the electrical energy storage device 6 respectively on the basis of the first operating modes B1, B4 of the further subsystems 1, 4 planned for the respective time t and of the first draw E2 of electrical energy planned for the respective time t. As a result, the electrical energy storage device 6 thus equalizes the difference between the electrical energy demand of the further subsystems 1, 4, on the one hand, and the—defined—first draw E2 of electrical energy.

The equalization is carried out for each time t or at least for smaller periods of typically at most 10% of the first time horizon T1. In most cases, the smaller periods are even smaller than the second time horizon T2. By way of example, the smaller periods may each be 15 minutes.

In a step S9, the control device 7, for the respective time t, drives the subsystems 1, 4, 6 in accordance with the operating modes B1, B4, B6 planned or determined for the respective time t, that is to say operates them in accordance with these operating modes B1, B4, B6. The control device 7 also drives the power converter 3, specifically such that electrical energy is drawn from the supply grid 2 in accordance with the planned first draw E2 of electrical energy.

In a step S10, the control device 7 checks whether a time t1 has been reached, that is to say the end of the first time horizon T1. If this is not the case, the control device 7 returns to step S8. Otherwise, the control device 7 transitions to a step S11.

In step S11, and thus starting from the time t1, the control device 7 determines the associated operating mode B6′ of the electrical energy storage device 6 respectively on the basis of the second operating modes B1′, B4′ of the further subsystems 1, 4 planned for the respective time t and of the second draw E2′ of electrical energy defined for the respective time t. The control device 7, in a step S12, for the respective time t, then drives the subsystems 1, 4, 6 in accordance with the operating modes B1′, B4′, B6′ planned or determined for the respective time t. The control device 7 also drives the power converter 3, specifically such that electrical energy is drawn from the supply grid 2 in accordance with the defined second draw E2′ of electrical energy. Steps S11 and S12 thus ultimately correspond in terms of content to steps S8 and S9, other than the fact that they relate to a different time.

In a step S13, the control device 7 checks whether a time t2 has been reached, that is to say the end of the second time horizon T2. If this is not the case, the control device 7 returns to step S11. Otherwise, the procedure of FIG. 2 is terminated.

FIG. 2 shows a simplified procedure. The real procedure is somewhat more complex. In reality, there is in particular a rolling procedure. Steps S1 to S13 are therefore carried out repeatedly, wherein the times t0, t1 and t2 are repeatedly adjusted and tracked so that in particular the second time horizon T2—with small fluctuations if necessary—always lies the same distance away in the future.

If for example—a typical case—the first time horizon T1 is 23 hours and the second time horizon T2 is 1 hour and a resolution of 1 hour is deployed, after the initial execution of the operating method according to the invention, the operating mode of the overall system is basically fixed for 24 hours. The period for which the operating mode of the overall system is fixed gradually decreases by 1 hour. At the end of this hour, the operating method is carried out again, wherein the operating mode of the overall system for the now 23rd hour has been defined by the previous execution of the operating method according to the invention, and the operating mode of the overall system is defined again for the now 24th hour.

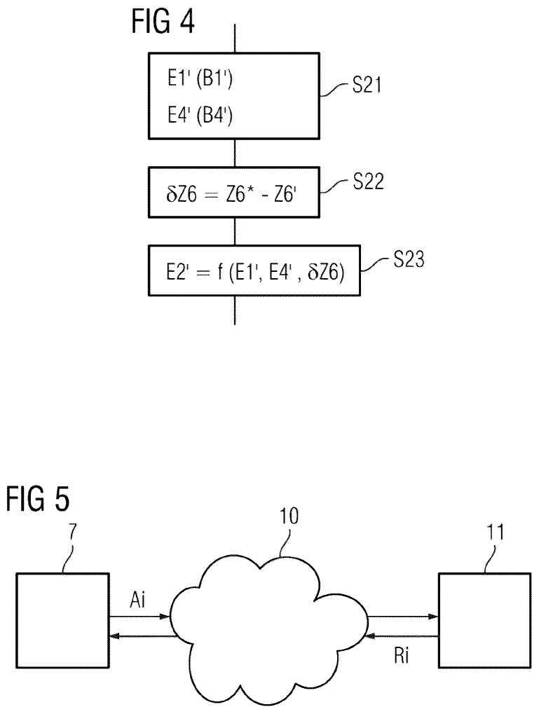

To define the planned second draw E2′ of electrical energy, that is to say to implement step S6, the control device 7 according to FIG. 4 first determines a demand for electrical energy E1′, E4′ for the operation of further subsystems 1, 4 during the second time horizon T2 in a step S21 based on the planned second operating modes B1′, B4′ for the further subsystems 1, 4. The control device 7 also, in a step S22, determines a difference δZ6 between the expected end state Z6′ of the electrical energy storage device 6 and a target state Z6* of the electrical energy storage device 6 desired at the end of the second time horizon T2, in particular a difference between the corresponding states of charge.

In a step S23, the control device 7 finally defines the second draw E2′ of electrical energy from the supply grid 2 during the second time horizon T2, taking into account the values determined in steps S21 and S22. In the simplest case, the control device 7 may simply calculate the sum.

The control device 7 may additionally be connected to an energy exchange 11 over the Internet 10, in accordance with the illustration in FIG. 5. In this case, the control device 7 may, in accordance with the illustration in FIG. 6, in a step S31, determine a respective number of requests Ai (with i=1, 2, 3, etc.) to draw electrical energy from the supply grid 2 for a number of portions of the second time horizon T2 (for example, in the case of a length of the second time portion T2 of 1 hour for four portions of one hour each). The requests Ai each comprise a desired quantity Mi of electrical energy and respective conditions Ci, for example a desired maximum price. Generally speaking, the requests Ai are staggered, that is to say they differ at least in terms of the respectively associated maximum price offered. The quantities Mi of electrical energy requested in each case are usually also different from one another, but may also be the same in some cases.

Generally speaking, the control device 7 takes the expected end state Z6′ of the electrical energy storage device 6 and/or operating limits of the electrical energy storage device 6 into account when defining the requests Ai. If for example it must be assumed that the electrical energy storage device 6 is almost empty at the end of the first time horizon T1, a relatively large draw E2′ of electrical energy must be secured for the second time horizon T2 in order for the overall system to continue to be able to be operated reliably. In this case, the operator of the overall system must be prepared to pay a relatively high price for the electrical energy. If, on the other hand, it may be assumed that the electrical energy storage device 6 is almost full at the end of the first time horizon T1, only a relatively small draw E2′ of electrical energy must be secured for the second time horizon T2 in order for the overall system to continue to be able to be operated reliably. For relatively large quantities of electrical energy, a very low maximum price may therefore be offered.

Similarly, the control device 7 may take operating limits of the electrical energy storage device 6 into account when defining the requests Ai. If—for example—during the second time horizon T2, the state of charge of the electrical energy storage device 6 is able to be changed by at most 30%, it does not make sense to request a quantity Mi of electrical energy that would ultimately result in a change in the state of charge of the electrical energy storage device 6 by more than 30%.

The control device 7 may, if necessary, also take into account an expected availability V (see FIG. 1) of electrical energy expected for periods beyond the second time horizon T2 when defining the requests Ai. The expected availability V may be specified to the control device 7 or be determined by the control device 7. The expected availability V—which is ultimately a presumption or estimate—is able to be determined by the control device 7, possibly on the basis of historical data about the expected availability V, that is to say ultimately the actual availability during comparable past periods, and/or a weather forecast. Taking into account the expected availability V makes it possible for example—within certain limits−to output requests Ai in which certain quantities Mi of electrical energy are combined with lower maximum prices, if it is able to be assumed with a sufficient probability that the prices of electrical energy will fall shortly after the second time horizon T2. A risk may be taken, so to speak.

In a step S32, the control device 7 outputs the requests Ai that it has determined to the energy exchange 11. In a step S33, the control device 7 receives responses Ri to the requests Ai. The responses Ri each contain the information as to whether or not, for the corresponding request Ai, the drawing of the requested quantity Mi of electrical energy, with the respectively associated conditions Ci being complied with, has been agreed to by the energy exchange 11.

In a step S34, the control device 7 then takes on the requests Ai for which the drawing of the requested quantities Mi of electrical energy, with the respectively associated conditions Ci being complied with, has been agreed to by the energy exchange 11, for the respective portion of the second time horizon T2 as a second draw E2′ of electrical energy.

The planned first operating modes B1, B4 are operating modes in which the corresponding subsystems 1, 4 are operated whenever possible during the first time horizon T1. In practice, however, not all circumstances are able to be taken into account in full when defining the planned first operating modes B1 and B4. Certain circumstances are always ignored. By way of example, in the case of a rolling mill as a raw materials industry installation 1, rolling stock may be slightly warmer or slightly colder than planned, and so rolling forces, rolling moments and the associated demand for electrical energy vary.

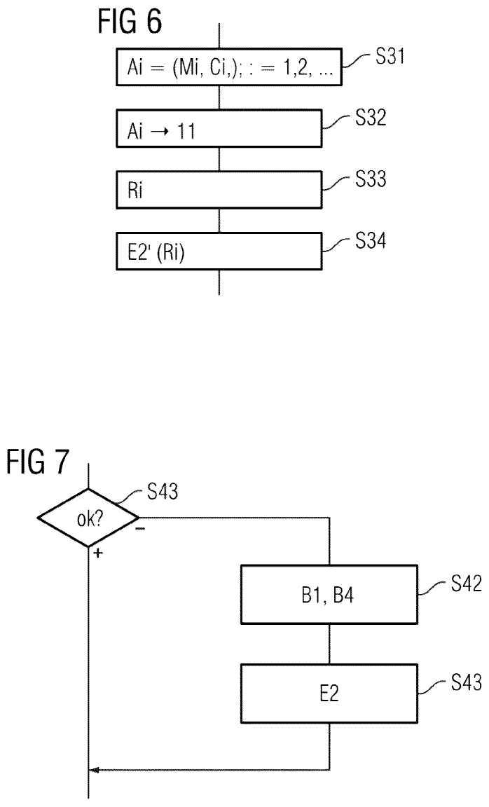

The control device 7 therefore also checks, during the first time horizon T1 according to FIG. 7, in a step S41, whether, during actual operation of the further subsystems 1, 4 and also during operation of the electrical energy storage device 6, operating limits of the electrical energy storage device 6 (for example maximum currents or a minimum or a maximum charge state) are complied with during the remaining part of the first time horizon T1. In other words: The planning has been carried out such that the operating limits are complied with. Due to the unconsidered circumstances, however, the electrical energy storage device 6 then operates differently than assumed. It is therefore now possible that, despite the planning and for example even despite having taken certain reserves into account when planning, the operating limits of the electrical energy storage device 6 are no longer complied with.

If the check in step S41 reveals that the operating limits are complied with, the control device 7 does not take any further measures with regard to the planned first draw E2 of electrical energy. In particular, it maintains the planned first draw E2 of electrical energy without any changes. If, on the other hand, the check in step S41 reveals that the operating limits are not complied with, the control device 7, in a step S42, modifies the planned first operating modes B1, B4—of course, only for the future, that is to say here the remaining part of the first time horizon T1. By way of example, a rolling speed may be adjusted or a production of hydrogen may be adjusted. As an alternative or in addition, the control device 7, in a step S43, modifies the planned first draw E2 of electrical energy, in this case too of course, only for the future, that is to say here the remaining part of the first time horizon T1. By way of example, the control device 7 may directly additionally purchase or return a certain draw of electrical energy on the energy exchange 11 for at least a portion of the remaining part of the first time horizon T1. In both step S42 and step S43, the measures taken are aimed at ensuring that the operating limits of the electrical energy storage device 6 are complied with. Step S3 may be implemented in the same way as the procedures in FIGS. 4 and 6.

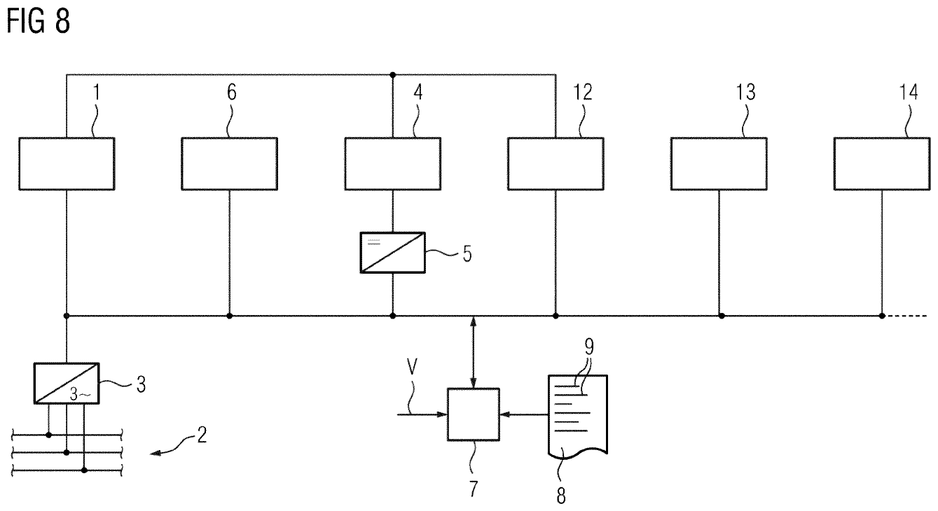

An explanation has been given here of an embodiment in which the overall system has, as subsystems 1, 4, 6, only the raw materials industry installation 1, the electrolysis installation 4 and the electrical energy storage device 6. However, according to FIG. 8, the overall system may also comprise other subsystems 12, 13, 14. These subsystems 12, 13, 14, if present, are further sub-systems in the sense of the present invention.

By way of example, the overall system may comprise a hydrogen storage device 12. The hydrogen storage device 12 may be designed as a storage device in a narrower sense, that is to say as a dedicated hydrogen storage device. However, the pipeline network via which hydrogen is transported also has a certain storage capacity and may serve as a hydrogen storage device 12. The hydrogen storage device 12, if present, is connected directly or indirectly to the electrolysis installation 4 in order to receive hydrogen and connected directly or indirectly to the installation 1 in order to output hydrogen. The operation of the installation 1 and of the electrolysis installation 4 is able to be made more flexible due to the hydrogen storage device 12.

If the hydrogen storage device 12 is present, it is possible for the hydrogen generated by the electrolysis installation 4 always to be supplied to the hydrogen storage device 12 and for any hydrogen required by the installation 1 always to be supplied by the hydrogen storage device 12, such that the hydrogen storage device 12 serves as a hydrogen transfer station, so to speak. However, a direct connection between the installation 1 and the electrolysis installation 4 is furthermore also possible.

As an alternative or in addition, the overall system may comprise a power generation device 13, for example a wind turbine or a photovoltaic installation. In this case, the power generation device 13 is connected directly or indirectly to the other electrical energy-receiving or outputting subsystems 1, 4, 6, and also to the electrical supply grid 2, in order to transmit electrical energy. A power converter, which is usually required for the power generation device 13, may be considered to be part of the power generation device 13. This is not also illustrated in FIG. 1. Preferably, it is possible to supply electrical energy from the power generation device 13 to the subsystems 1, 4, 6 without a diversion via the supply grid 2.

If the hydrogen storage device 12 and/or the power generation device 13 are present, the procedures of FIGS. 2, 4 and 6 must be extended and supplemented by taking into account the corresponding initial states, operating modes, driving and end states of these two subsystems 12, 13.

Above all, however, the overall system—in addition to the electrical energy storage device 6—may comprise a further electrical energy storage device 14 as a further subsystem. To distinguish them linguistically from one another, the further electrical energy storage device 14 is hereafter always referred to as such, while the electrical energy storage device 6 that has already been explained in conjunction with FIG. 1, where necessary, is referred to as the other electrical energy storage device 6.

The further electrical energy storage device 14 is electrically connected directly or indirectly to the other subsystems 1, 4, 6, etc. and the electrical supply grid 2. The further electrical energy storage device 14 may also be operated independently of the other electrical energy storage device 6. It is therefore possible to set, independently of the other energy storage device 6, whether and to what extent electrical energy is supplied to the further energy storage device 14 or whether and to what extent the further electrical energy storage device 14 outputs electrical energy. For this purpose, a separate bidirectionally operable power converter unit is generally present for the further electrical energy storage device 14. This power converter unit is not also illustrated in FIG. 8. Rather, it is considered to be part of the further electrical energy storage device 14.

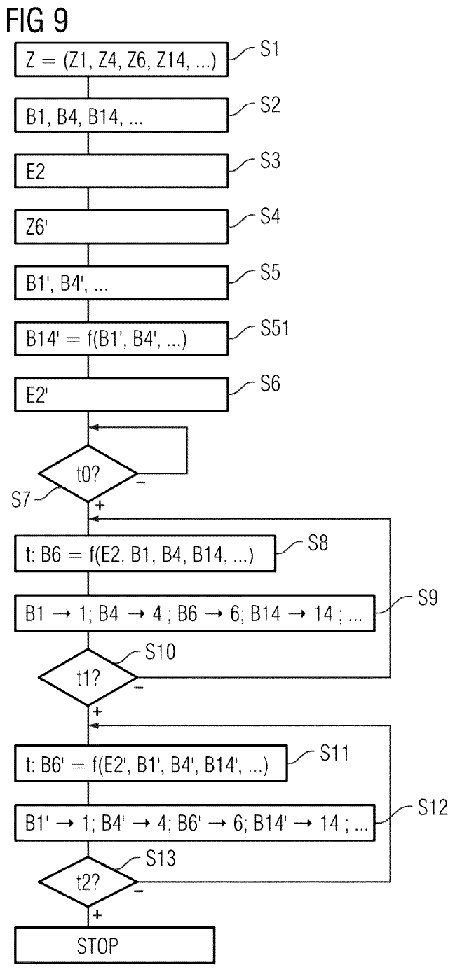

Due to the presence of the further electrical energy storage device 14, the operating mode of the overall system as explained above in conjunction with FIG. 2 is modified. This is explained in more detail below in conjunction with FIG. 9.

One modification that is always present is—of course—the fact that the procedure also takes into account the further electrical energy storage device 14. The control device 7 is thus also made aware of a current substate Z14 for the further electrical energy storage device 14 (see step S1 in FIG. 9). The control device 7 is furthermore made aware of both a planned first operating mode B14 for the first time horizon T1 (see step S2 in FIG. 9) and a planned second operating mode B14′ for the further electrical energy storage 14 for the second time horizon T2. Substate Z14 is also utilized in the same way as the other substates Z1, Z4, Z6, and the operating modes B14 and B14′ are utilized in the same way as the other first and second operating modes B1, B4, B1′, B4′ of the further subsystems 1, 4 (cf. for example steps S8, S9, S11 and S12 in FIG. 9). The current substate Z14 may—of course for the further electrical energy storage device 14—comprise the same variables as substate Z6 of the electrical energy storage device 6.

A further modification, which, although not necessarily present, will usually be present, is the way in which the control device 7 is made aware of the second operating mode B14′ for the further electrical energy storage device 14. This is because, according to FIG. 9, there is a step S51 between steps S5 and S6. In step S51, the control device 7, utilizing the planned second operating modes B1′, B4′ of the further subsystems 1, 4—that is to say the further subsystems 1, 4 with the exception of the further electrical energy storage device 14—defines the planned second operating mode B14 of the further energy storage device 14. If necessary, states of the further subsystems 1, 4 (including the further electrical energy storage device 14) that are expected for the transition from the first to the second time horizon T1, T2 may also be incorporated into the determination in step S51. These states may, if necessary, be determined from the corresponding current states Z1, Z4 and the associated first operating modes B1, B4. In any case, however, the control device 7 carries out step S6, in which it defines the planned second draw E2′ of electrical energy, only after step S51.

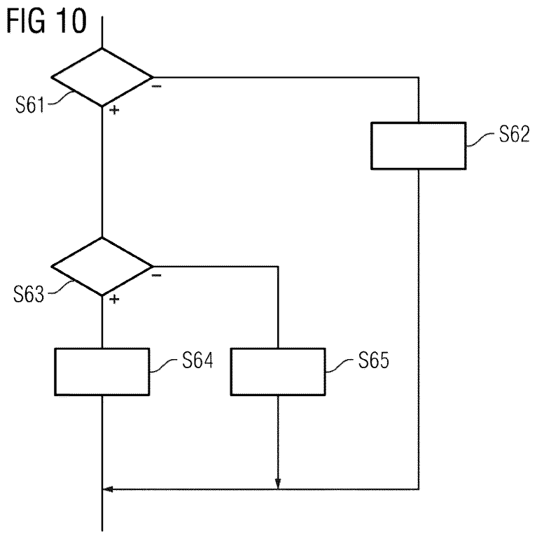

Due to the further electrical energy storage device 14, the procedure of FIG. 7 may furthermore be modified as explained below in conjunction with FIG. 10.

According to FIG. 10, the control device 7 checks, during the first time horizon T1, in a step S61, whether, during actual operation of the further subsystems 1, 4 (with the exception of the further electrical energy storage device 14), the electrical energy demand of the further subsystems 1, 4 deviates from an energy demand in accordance with the corresponding planned first operating modes B1, B4.

If the energy demand does not deviate, the control device 7 transitions to a step S62. In step S62, the control device 7 maintains the planned first operating modes B6, B14 of both electrical energy storage devices 6, 14 without any changes. The planned first operating mode B6 of the electrical energy storage device 6 has been determined beforehand based on the planned first draw E2 of electrical energy from the supply grid 2. The control device 7 thus in particular also maintains the planned first draw E2 of electrical energy from the supply grid 2 without any changes.

If, on the other hand, the energy demand deviates, the control device 7 transitions to a step S63. In step S63, the control device 7 checks whether modifying the planned first operating mode B14 and/or the planned first operating mode B6—of course, taking into account the operating limits of the two electrical energy storage devices 6, 14—makes it possible to maintain the planned first draw E2 of electrical energy from the supply grid 2. If the planned first draw E2 of electrical energy is able to be maintained, the control device 7 transitions to a step S64, in which it modifies the planned first operating mode B6 and/or the planned first operating mode B14 accordingly. However, the control device 7, in step S64, continues to maintain the planned first draw E2 of electrical energy from the supply grid 2 without any changes. The first operating modes B1, B4 of the further subsystems 1, 4 are also changed only to the extent that this is absolutely necessary due to the problems that have occurred.

Carrying out step S64 allows for example the further electrical energy storage device 14 to bridge the problem for a short time. If necessary, the operating mode of the other electrical energy storage device 14 may additionally also be changed. Later on, for example, the state of the further electrical energy storage device 14 may then be approximated again to the state in which it would have been without the problem. However, all this takes place without the electrical energy drawn from the supply grid 2 being modified.

If, on the other hand, the planned first draw E2 of electrical energy from the supply grid 2 cannot be maintained even if the planned first operating mode B14 and/or the planned first operating mode B6 are/is modified, the control device 7 transitions to a step S65. In step S65, the control device 7 modifies not just (where possible) the planned first operating modes B6, B14 of the two electrical energy storage devices 6, 14. Rather, the control device 7, in step S65, also modifies the planned first draw E2 of electrical energy from the supply grid 2 and/or the planned first operating modes B1, B4 of the other further sub-systems 1, 4. The modification is carried out such that the operating limits of the two electrical energy storage devices 6, 14 are complied with. In some cases, it may also make sense to carry out the modification such that the planned first draw E2 of electrical energy from the supply grid 2 is also changed as little as possible. In other cases, it may be the case that this is not effective and may therefore be ignored.

The overall system may additionally also comprise other further subsystems. This is not illustrated in FIG. 1. In this case too, the procedures of FIGS. 2, 4 and 6 must be extended and supplemented by taking into account the corresponding initial states, operating modes, driving and end states of these subsystems.

The present invention has many advantages. The prior definition and subsequent implementation of the drawing E2′ of electrical energy from the supply grid 2 means that the costs of the electrical energy are reliably known. In particular, participation on the Internet exchange 11 even makes it possible to minimize the costs of electrical energy. It is also easily possible for example to integrate longer-term purchase contracts or a separate power generation device 13.

Although the invention has been illustrated and described in detail by the preferred working examples, the invention is not limited by the examples disclosed and other variations may be derived therefrom by a person skilled in the art without departing from the scope of protection of the invention.

### LIST OF REFERENCE SIGNS

1 Installation
2 Supply grid
3 Power converter
4 Electrolysis installation
5 Rectifier
6 Energy storage device
7 Control device
8 Control program
9 Machine code
10 Internet
11 Energy exchange
12 Hydrogen storage device
13 Power generation device
14 Further energy storage device
Ai Requests
B1, B4, B6, B14 First operating modes
B1′, B4′, B6′, B14′ Second operating modes
Ci Conditions
E1′, E4′ Demands for electrical energy
E2, E2′ Draws of electrical energy
Mi Quantities of electrical energy
Ri Responses
S1 to S65 Steps
T1, T2 Time horizons
t0, t1, t2 Times
V Availability
Z1, Z4, Z6, Z14 Current states
Z6′ Expected end state
Z6* Target state
δZ6 difference

1. An operating method for an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein a control device that controls the overall system is made aware of current states of the subsystems,
wherein the control device is made aware, with respect to a first time horizon (T1), of a planned first draw (E2) of electrical energy from the supply grid and planned first operating modes (B1, B4) of the further subsystems,
wherein the control device determines an expected end state of the electrical energy storage device with respect to the end of the first time horizon (T1), based on the planned first draw (E2) and the planned first operating modes (B1, B4),
wherein the control device (defines a planned second draw (E2′) of electrical energy taking into account the expected end state (Z6′) of the electrical energy storage device and second operating modes (B1′, B4′) of the further subsystems that are known to the control device and planned for a second time horizon (T2) immediately following the first time horizon (T1),
wherein the control device operates the further sub-systems during the first and second time horizon (T1, T2) based on the planned first and second operating modes (B1, B4, B1′, B4′) and draws electrical energy from the supply grid during the first and second time horizon (T1, T2) in accordance with the planned first draw (E2) and the defined second draw (E2′) of electrical energy,
wherein the control device, in order to define the planned second draw (E2′) of electrical energy,
determines a demand (E1′, E4′) for electrical energy for the operation of the further subsystems during the second time horizon (T2) based on the planned second operating modes (B1′, B4′), and
defines the second draw (E2′) of electrical energy from the supply grid ()during the second time horizon (T2) taking into account the demand (E1′, E4′) for electrical energy for the operation of the further subsystems during the second time horizon (T2) and the expected end state (Z6′) of the electrical energy storage device and a target state (Z6*) of the electrical energy storage device desired at the end of the second time horizon (T2).

2. The operating method as claimed in claim 1, wherein
the overall system comprises a further electrical energy storage device as a further subsystem.

3. The operating method as claimed in claim 2, wherein
the control device first defines the planned second operating mode (B14′) of the further energy storage device by utilizing the planned second operating modes (B1′, B4′) of the further subsystems with the exception of the further electrical energy storage device and only then defines the planned second draw (E2′) of electrical energy.

4. The operating method as claimed in claim 2, wherein the control device
checks, during the first time horizon (T1), whether the electrical energy demand of the further subsystems, with the exception of the further electrical energy storage device (14), deviates from an energy demand in accordance with the planned first operating modes (B1, B4) due to unconsidered circumstances,
in the event that the energy demand does not deviate, maintains the planned first operating mode (B14) of the further electrical energy storage device and a planned first operating mode (B6) of the electrical energy storage device based on the planned first draw (E2) of electrical energy from the supply grid and
in the event that the energy demand deviates,
modifies the planned first operating mode (B14) of the further electrical energy storage device and/or the planned first operating mode (B6) of the electrical energy storage device (6) as a priority, so that the planned first draw (E2) of electrical energy from the supply grid is maintained, and
modifies the planned first operating modes (B1, B4) of the further subsystems, with the exception of the further electrical energy storage device, and/or the planned first draw (E2) of electrical energy, only if operating limits of the electrical energy storage device and/or the further electrical energy storage device cannot be complied with, such that the operating limits of the electrical energy storage device and the further electrical energy storage device are complied with.

5. The operating method as claimed in claim 1, wherein the control device (7)
checks, during the first time horizon (T1), whether operating limits of the electrical energy storage device are complied with during the remaining part of the first time horizon (T1), despite unconsidered circumstances,
maintains the planned first draw (E2) of electrical energy in the event that the operating limits are complied with, and
modifies the planned first operating modes (B1, B4) and/or the planned first draw (E2) of electrical energy, in the event that the operating limits are not complied with, such that the operating limits of the electrical energy storage device are complied with.

6. The operating method as claimed in claim 1, wherein
the overall system comprises an electrolysis installation as a further subsystem,
the electrolysis installation is connected directly or indirectly to the metal industry installation, the electrical energy storage device and the electrical supply grid in order to transmit electrical energy,
the current states (Z1, Z4, Z6) comprise a current state (Z4) of the electrolysis installation and
the planned first and second operating modes (B1, B4) comprise a respective operating mode (B4, B4′) for the electrolysis installation.

7. A control program for a control device (7) for an overall system,
wherein the overall system comprises, as a subsystem, an electrical energy storage device (6) and further subsystems,
wherein the further subsystems comprise a metal industry installation,
wherein the metal industry installation and the electrical energy storage device are connected directly or indirectly to one another and to an electrical supply grid in order to transmit electrical energy,
wherein the control program comprises machine code able to be executed by the control device,
wherein the execution of the machine code by the control device causes the control device to control the overall system in line with an operating method as claimed in claim 1.

8. A control device for an overall system,
wherein the overall system comprises, as a subsystem, an electrical energy storage device and further subsystems,
wherein the further subsystems comprise a metal industry installation,
wherein the metal industry installation and the electrical energy storage device are connected directly or indirectly to one another and to an electrical supply grid in order to transmit electrical energy,
wherein the control device is programmed, by way of a control program to control the overall system in line with an operating method as claimed in claim 1.

9. An overall system,
wherein the overall system comprises, as a subsystem, an electrical energy storage device and further subsystems,
wherein the further subsystems comprise a metal industry installation
wherein the metal industry installation and the electrical energy storage device are connected directly or indirectly to one another and to an electrical supply grid in order to transmit electrical energy,
wherein the overall system comprises a control device as claimed in claim 8.
